(19) United States
(12) Patent Application Publication
(10) Pub. No.: US 2019/0227639 A1
(43) Pub. Date: Jul. 25, 2019

(54) KEYBOARD DEVICE

(71) Applicant: Primax Electronics Ltd., Taipei (TW)

(72) Inventors: Bo-An Chen, Taipei (TW); Chin-Sung Pan, Taipei (TW); Lei-Lung Tsai, Taipei (TW); Yi-Chen Wang, Taipei (TW)

(21) Appl. No.: 15/991,138

(22) Filed: May 29, 2018

(30) Foreign Application Priority Data
Jan. 19, 2018 (TW) 107102087

(51) Int. Cl. G06F 3/02; G06K 9/00; G06F 1/16; G06F 21/32; H01H 13/7065

(52) U.S. Cl. CPC G06F 3/021; G06K 9/0004; H01H 13/7065; G06F 3/0219; G06F 21/32; G06F 1/1662

(57) ABSTRACT

A keyboard device includes a key structure, a switch circuit board, a supporting plate and an identification module. The key structure includes a keycap and a fingerprint sensing module. The fingerprint sensing module is installed on an inner surface of the keycap in order to acquire a fingerprint information of a finger. The identification module is located under the supporting plate and electrically connected with the fingerprint sensing module. The identification module receives the fingerprint information and determines whether an unlocking operation of unlocking a computer is performed according to the fingerprint information. Since the keycap is not equipped with a hollow region and the fingerprint sensing module is not exposed, the keyboard device has the aesthetically-pleasing appearance.

### FIELD OF THE INVENTION

The present invention relates to an input device, and more particularly to a keyboard device with plural keys.

### BACKGROUND OF THE INVENTION

Generally, the widely-used peripheral input device of a computer system includes for example a mouse device, a keyboard device, a trackball device, or the like. Via the keyboard device, characters or symbols can be directly inputted into the computer system. As a consequence, most users and most manufacturers of input devices pay much attention to the development of keyboard devices.

The structure of a conventional keyboard device will be described as follow. FIG. 1 is a schematic cross-sectional side view illustrating the structure of a conventional keyboard device. The conventional keyboard device 1 comprises plural keys 10, a switch circuit member 11 and a supporting plate 12. Each key 10 comprises a keycap 101, a scissors-type connecting element 102 and an elastic element 103. In the key 10, the keycap 101 is exposed outside the conventional keyboard device 1. Consequently, the keycap 101 can be depressed by the user. The scissors-type connecting element 102 is used for connecting the keycap 101 and the supporting plate 12. The elastic element 103 is penetrated through the scissors-type connecting element 102. In addition, both ends of the elastic element 103 are contacted with the keycap 101 and the switch circuit member 11, respectively. The supporting plate 12 is located under the switch circuit member 11. The keycap 101, the scissors-type connecting element 102, the elastic element 103 and the switch circuit member 11 are supported on the supporting plate 12.

The switch circuit member 11 comprises an upper wiring board 111, a separation layer 112, and a lower wiring board 113. The upper wiring board 111 has plural upper contacts 1111. The separation layer 112 is located under the upper wiring board 111, and comprises plural perforations 1121 corresponding to the plural upper contacts 1111. The lower wiring board 113 is located under the separation layer 112, and comprises plural lower contacts 1131 corresponding to the plural upper contacts 1111. The plural lower contacts 1131 and the plural upper contacts 1111 are collectively defined as plural key switches 114. The elastic elements 103 are disposed on the switch circuit member 11 and aligned with the corresponding key switches 114.

The operations of the key 10 of the conventional keyboard device 1 in response to the depressing action of the user will be illustrated as follows. Please refer to FIG. 1 again. When the keycap 101 is depressed, the keycap 101 is moved downwardly to push the scissors-type connecting element 102 in response to the depressing force. Consequently, the scissors-type connecting element 102 is correspondingly moved with the keycap 101. As the keycap 101 is moved downwardly relative to the supporting plate 12, the keycap 101 pushes the corresponding elastic element 103. At the same time, the elastic element 103 is subjected to deformation to push the switch circuit member 11 and trigger the corresponding key switch 114 of the switch circuit member 11. Consequently, the switch circuit member 11 generates a corresponding key signal. When the keycap 101 is no longer depressed by the user, no external force is applied to the keycap 101 and the elastic element 103 is no longer pushed by the keycap 101. In response to the elasticity of the elastic element 103, the elastic element 103 is restored to its original shape to provide an upward elastic restoring force. Consequently, the keycap 101 is returned to its original position where it is not depressed. The structures and the operations of the conventional keyboard device have been mentioned as above. Moreover, the conventional keyboard device 1 can be applied to a notebook computer 13. In FIG. 2, the notebook computer 13 with the keyboard device 1 is shown.

Generally, the operating system in the notebook computer 13 provides a locking function in order to protect the user's privacy. For unlocking the notebook computer 13, the user has to use the keyboard device 1 to input a password corresponding to the user account. The password is usually the combination of six or more English letters and numbers. Recently, more and more attention has been paid to the personal privacy. Consequently, the way of unlocking the computer is not restricted to the process of inputting the password through the keyboard device. For example, a fingerprint identification technology has been used to unlock the notebook computer. By using the fingerprint identification technology, the user's fingerprint can be inputted into a notebook computer or any other appropriate electronic device and saved in the electronic device. For unlocking the electronic device, the user has to input the fingerprint through a fingerprint sensing module. The way of unlocking the electronic device by the fingerprint identification technology is faster and more user-friendly than the way of manually inputting the password. Consequently, the fingerprint identification technology is favored by many users.

A keyboard device with the fingerprint sensing module has been introduced into the market. For example, according to the technology disclosed in Taiwanese Utility Model No. TWM515672, the fingerprint sensing module is installed at the position corresponding to the space key of the keyboard device. Moreover, the keycap of the space key has a hollow region corresponding to the fingerprint sensing module. The fingerprint sensing module is penetrated through the hollow region and exposed outside the keycap. When the user's finger is placed on the fingerprint sensing module that is exposed outside the keycap, the fingerprint information of the finger can be acquired to unlock the electronic device. However, the technology disclosed in Taiwanese Utility Model No. TWM515672 still has some drawbacks. Firstly, the exposed fingerprint sensing module is not aesthetically pleasing. Secondly, the dust is readily introduced into the inner portion of the keyboard device through the vacant space between the hollow region of the keycap and the fingerprint sensing module, or even accumulated in the inner portion of the keyboard device. Thirdly, since the fingerprint sensing module is disposed within the hollow region of the keycap, the fingerprint sensing module is unavoidably contacted with the keycap when the keycap is depressed. In other words, the tactile feel of depressing the key is adversely affected.

Therefore, there is a need of providing a keyboard device with the aesthetically-pleasing appearance, the dustproof efficacy and the fingerprint identification function.

### SUMMARY OF THE INVENTION

An object of the present invention provides a keyboard device with the aesthetically-pleasing appearance, the dustproof efficacy and the fingerprint identification function.

In accordance with an aspect of the present invention, there is provided a keyboard device. The keyboard device includes a key structure, a switch circuit board, a supporting plate and an identification module. The key structure includes a keycap and a fingerprint sensing module. The keycap is exposed outside the keyboard device. The fingerprint sensing module is installed on an inner surface of the keycap. When a finger placed on an outer surface of the keycap is detected by the fingerprint sensing module, a fingerprint information of the finger is acquired. The switch circuit board is located under the key structure. When the switch circuit board is triggered by the key structure, a key signal is generated. The supporting plate is located under the switch circuit board. The key structure and the switch circuit board are supported by the supporting plate. The identification module is electrically connected with the fingerprint sensing module to receive the fingerprint information. The identification module determines whether an unlocking operation is performed according to the fingerprint information. The fingerprint sensing module is covered by the keycap and not exposed.

In an embodiment, the identification module includes a main circuit board and a control unit. The main circuit board is located under the supporting plate and electrically connected with an electric connection part of the fingerprint sensing module. The control unit is disposed on the main circuit board, and receives the fingerprint information from the fingerprint sensing module through the main circuit board and the electric connection part. If the control unit judges that the fingerprint information is successfully identified, the unlocking operation is performed. If the control unit judges that the fingerprint information is not successfully identified, a failed identification message is generated.

From the above descriptions, the present invention provides the keyboard device. The fingerprint sensing module is installed on the inner surface of the keycap. Since the fingerprint sensing module is not exposed outside the keycap, the appearance of the keyboard device is aesthetically pleasing. Since the fingerprint sensing module is installed on the inner surface of the keycap, the fingerprint sensing module is movable upwardly or downwardly with the keycap. Consequently, the movement of the keycap is not hindered by the fingerprint sensing module. In other words, the arrangement of the fingerprint sensing module in the keyboard device does not influence the tactile feel of depressing the keycap. Moreover, since the identification module is located under the supporting plate and the identification module is electrically connected with the fingerprint sensing module, the key structure has the fingerprint identification function. In comparison with the conventional technology, the keycap of the keyboard device of the present invention is not equipped with the hollow region. Consequently, the keyboard device has the aesthetically-pleasing appearance and the dust-proof efficacy.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional side view illustrating the structure of a conventional keyboard device;

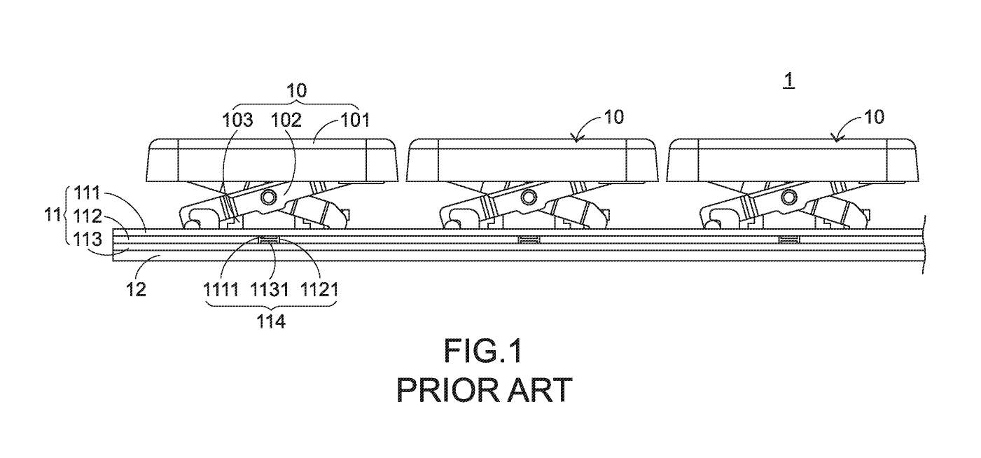

FIG. 2 schematically illustrates a notebook computer with the conventional keyboard device;

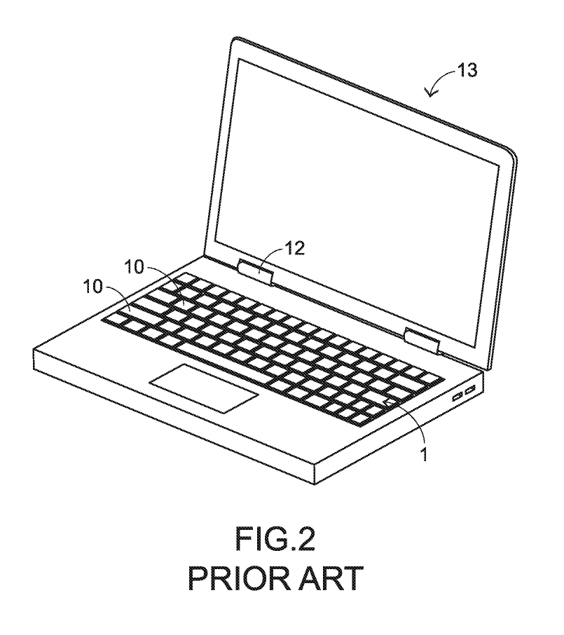

FIG. 3 is a schematic top view illustrating the outer appearance of a keyboard device according to an embodiment of the present invention;

FIG. 4 is a schematic exploded view illustrating a portion of the keyboard device according to the embodiment of the present invention;

FIG. 5 is a schematic perspective view illustrating a portion of the keycap and a fingerprint sensing module of the keyboard device according to the embodiment of the present invention;

FIG. 6 is a schematic perspective view illustrating a portion of the keyboard device according to the embodiment of the present invention; and

FIG. 7 is a schematic cutaway view illustrating a portion of the keyboard device according to the embodiment of the present invention.

### DETAILED DESCRIPTION OF THE PREFERRED EMBODIMENT

For solving the drawbacks of the conventional technologies, the present invention provides a keyboard device.

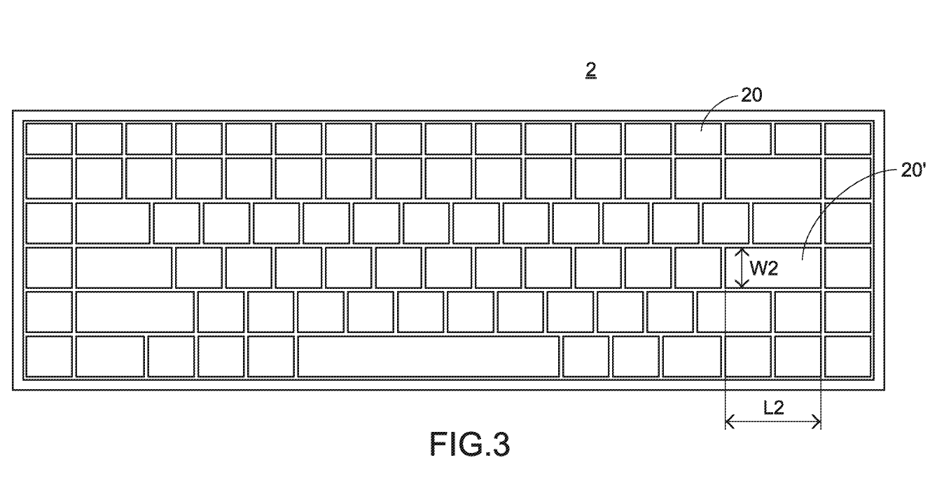

The structure of the keyboard device will be illustrated as follows. FIG. 3 is a schematic top view illustrating the outer appearance of a keyboard device according to an embodiment of the present invention. The keyboard device 2 comprises plural key structures 20 and 20′. The plural key structures 20 and 20′ are exposed outside the keyboard device 2. When one of the key structures 20 and 20′ is depressed by the user's finger, a corresponding key signal is generated to a computer (not shown) that is in communication with the keyboard device 2. According to the key signal, the computer executes a function corresponding to the depressed key structure. The length of the key structure 20 is slightly larger than the width of the key structure 20. The length L2 of the key structure 20′ is much larger than the width W2 of the key structure 20′. Since the size of the key structure 20′ is much larger than the size of the key structure 20, the key structure 20′ is also referred as a multiple key.

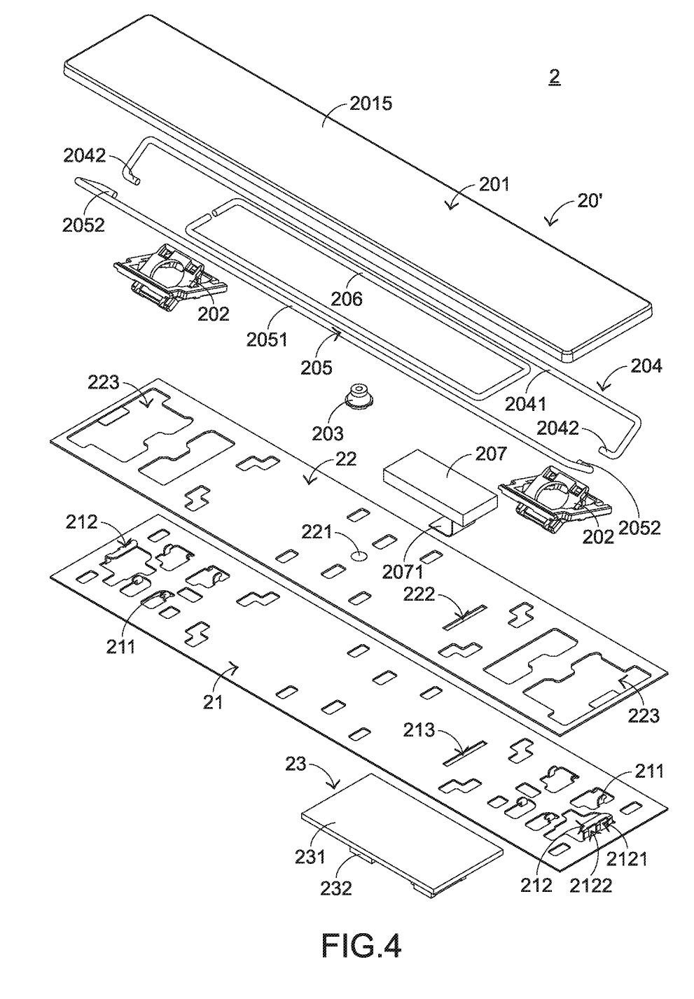

The inner structure of the keyboard device 2 will be described as follows. FIG. 4 is a schematic exploded view illustrating a portion of the keyboard device according to the embodiment of the present invention. For succinctness, only the key structure 20′ is shown. In addition to the plural key structures 20 and 20′, the keyboard device 2 further comprises a supporting plate 21, a switch circuit board 22 and an identification module 23. The supporting plate 21 is located under the plural key structures 20 and 20′. The supporting plate 21 is connected with the plural key structures 20 and 20′. The switch circuit board 22 is arranged between the plural key structures 20 and 20′ and the supporting plate 21. When the switch circuit board 22 is triggered by one of the plural key structures 20 and 20′, a corresponding key signal is generated. The switch circuit board 22 comprises plural key switches 221, a first opening 222 and plural second openings 223. The plural key switches 221 of the switch circuit board 22 are aligned with the corresponding key structures 20 and 20′. When one of the key switches 221 is triggered by the corresponding key structure 20 or 20′, the corresponding key signal is generated. The functions of the first opening 222 and the plural second openings 223 will be described later.

Please refer to FIG. 4 again. Each key structure 20′ of the keyboard device 2 comprises a keycap 201, at least one scissors-type connecting element 202, an elastic element 203, a first stabilizer bar 204 and a second stabilizer bar 205. The scissors-type connecting element 202 is connected with the corresponding keycap 201 and the supporting plate 21. Through the scissors-type connecting element 202, the keycap 201 is fixed on the supporting plate 21 and movable relative to the supporting plate 21. The elastic element 203 is arranged between the corresponding keycap 201 and the switch circuit board 22, and aligned with the corresponding key switch 221. When the elastic element 203 is pushed by the keycap 201, the corresponding key switch 221 is triggered by the elastic element 203. In an embodiment, the supporting plate 21 is made of a metallic material, the elastic element 203 is a rubbery elastomer, and the scissors-type connecting element 202 is made of a plastic material.

Please refer to FIG. 4 again. Both of the first stabilizer bar 204 and the second stabilizer bar 205 are connected with the keycap 201. The first stabilizer bar 204 comprises a first linking bar part 2041 and two first hook parts 2042. The first linking bar part 2041 is connected with the keycap 201. The two first hook parts 2042 are located at two ends of the first linking bar part 2041, respectively. Similarly, the second stabilizer bar 205 comprises a second linking bar part 2051 and two second hook parts 2052. The second linking bar part 2051 is connected with the keycap 201. The two second hook parts 2052 are located at two ends of the second linking bar part 2051, respectively. In this embodiment, the first linking bar part 2041 and the two first hook parts 2042 are integrally formed, and the first stabilizer bar 204 is made of a metallic material or a plastic material. Similarly, the second linking bar part 2051 and the two second hook parts 2052 are integrally formed, and the second stabilizer bar 205 is made of a metallic material or a plastic material.

The supporting plate 21 comprises plural supporting plate hooks 211, plural connecting structures 212 and a third opening 213. The plural supporting plate hooks 211 are penetrated through the corresponding second openings 223 of the switch circuit board 22. Moreover, the plural supporting plate hooks 211 are connected with the corresponding scissors-type connecting elements 202 in order to fix the scissors-type connecting elements 202 on the supporting plate 21. The connecting structures 212 are disposed on the supporting plate 21. The connecting structures 212 are penetrated through the corresponding second openings 223 of the switch circuit board 22 and located over the switch circuit board 22. Consequently, the connecting structures 212 are connected with the first stabilizer bar 204 and the second stabilizer bar 205. Each of the connecting structures 212 comprises a first locking hole 2121 and a second locking hole 2122. The first hook parts 2042 of the first stabilizer bar 204 are penetrated through the corresponding first locking holes 2121, so that the first stabilizer bar 204 is fixed on the supporting plate 21. The second hook parts 2052 of the second stabilizer bar 205 are penetrated through the corresponding second locking holes 2122, so that the second stabilizer bar 205 is fixed on the supporting plate 21.

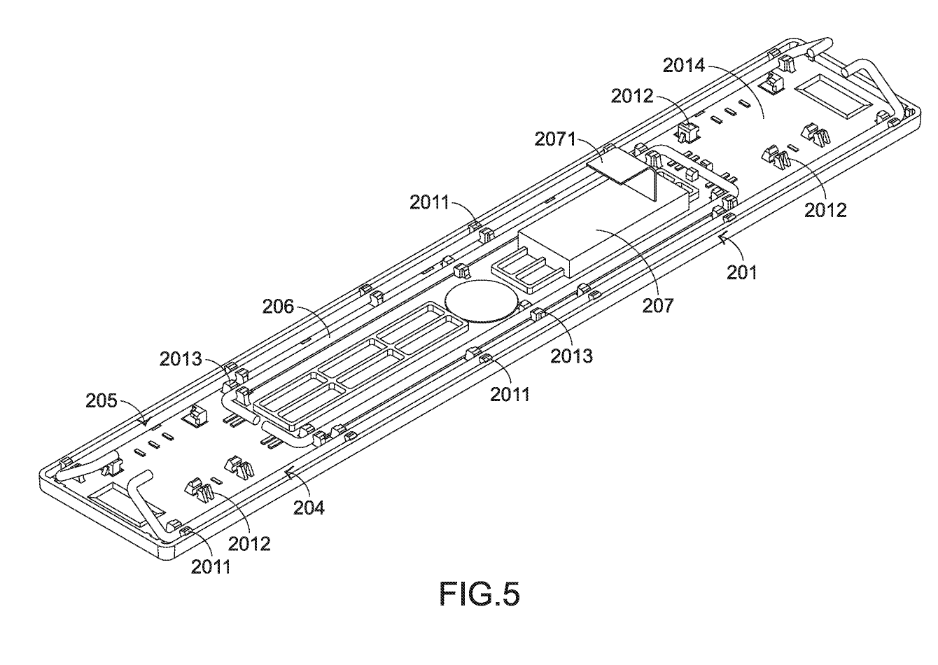

FIG. 5 is a schematic perspective view illustrating a portion of the keycap and a fingerprint sensing module of the keyboard device according to the embodiment of the present invention. Please refer to FIGS. 4 and 5. Moreover, the keycap 201 comprises plural first keycap hooks 2011, plural second keycap hooks 2012 and plural third keycap hooks 2013. The plural second keycap hooks 2012 are disposed on an inner surface 2014 of the keycap 201 and connected with the corresponding scissors-type connecting element 202. The plural first keycap hooks 2011 are also disposed on the inner surface 2014 of the keycap 201. The first keycap hooks 2011 are connected with the first linking bar part 2041 and the second linking bar part 2051. Consequently, the first stabilizer bar 204 and the second stabilizer bar 205 are fixed on the keycap 201. For increasing the structural strength of the keycap 201, the key structure 20′ of the keyboard device 2 further comprises a reinforcement element 206 and the keycap 201 further comprises the plural third keycap hooks 2013 corresponding to the reinforcement element 206. The reinforcement element 206 is a substantially a rectangular ring-shape rod. The plural third keycap hooks 2013 are connected with the reinforcement element 206. Since the reinforcement element 206 is fixed on the inner surface 2014 of the keycap 201, the structural strength of the keycap 201 is increased.

For achieving a fingerprint identification function, a specified key structure 20′ of the plural key structures 20′ of the keyboard device 2 is further equipped with a fingerprint sensing module 207. The fingerprint sensing module 207 is disposed on the inner surface 2014 of the keycap 201 of the specified key structure 20′. When a finger (not shown) is placed on an outer surface 2015 of the keycap 201, the fingerprint information of the finger is acquired by the fingerprint sensing module 207. Moreover, the fingerprint sensing module 207 is covered by the keycap 201. That is, the fingerprint sensing module 207 is not exposed outside. In an embodiment, the specified key structure 20′ equipped with the fingerprint sensing module 207 is a space key. It is noted that the example of the specified key structure 20′ is not restricted.

Moreover, the identification module 23 corresponds to the fingerprint sensing module 207. The identification module 23 is located under the supporting plate 21 and electrically connected with the fingerprint sensing module 207. The identification module 23 receives the fingerprint information. According to the fingerprint information, the identification module 23 judges whether an unlocking operation will be performed or not. In an embodiment, the identification module 23 comprises a main circuit board 231 and a control unit 232. The main circuit board 231 is located under the supporting plate 21 and electrically connected with an electric connection part 2071 of the fingerprint sensing module 207. The control unit 232 is disposed on the main circuit board 231. The control unit 232 receives the fingerprint information from the fingerprint sensing module 207 through the main circuit board 231 and the electric connection part 2071. Moreover, a predetermined fingerprint data has been stored in the control unit 232. According to the result of comparing the fingerprint information with the predetermined fingerprint data, the control unit 232 determines whether an unlocking operation will be performed or not. In an embodiment, the control unit 232 is a microprocessor, and the main circuit board 231 is a printed circuit board.

In an embodiment, the fingerprint sensing module 207 emits an invisible light. The invisible light is transmitted through the keycap 201. When the finger is placed on the keycap 201, the invisible light is projected onto the finger. Consequently, the fingerprint information of the finger is obtained. In other words, the keycap 201 should have the capability of allowing the invisible light to pass through. In an embodiment, the keycap 201 is made of a plastic material. Moreover, the transmittance of the plastic material in the invisible spectrum is larger than or equal to 95%, and the refractive index of the plastic material is larger than or equal to 1.5. The fingerprint sensing module 207 is attached on the inner surface 2014 of the keycap 201 through an optical clear adhesive. Consequently, the transmission of the invisible light is not adversely affected.

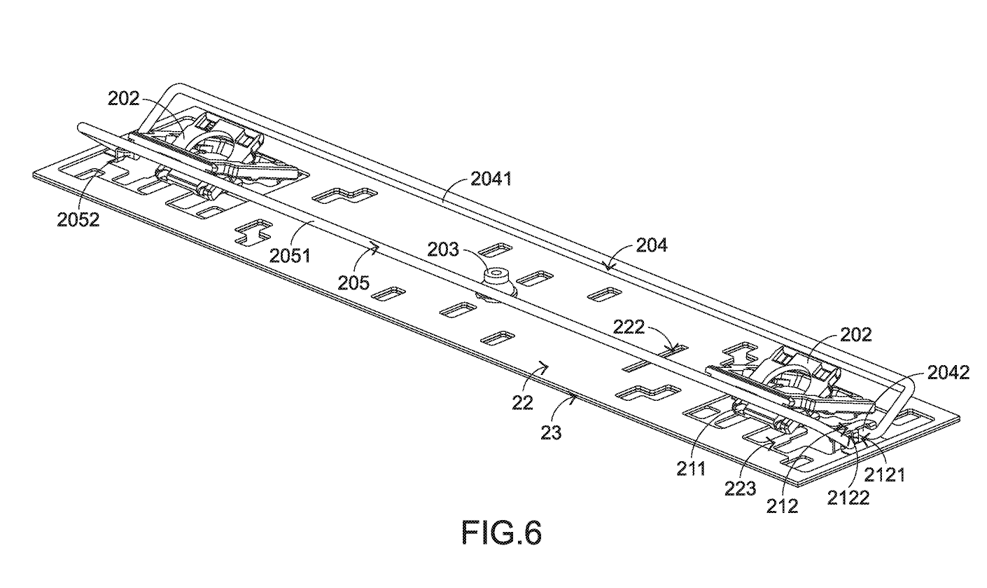

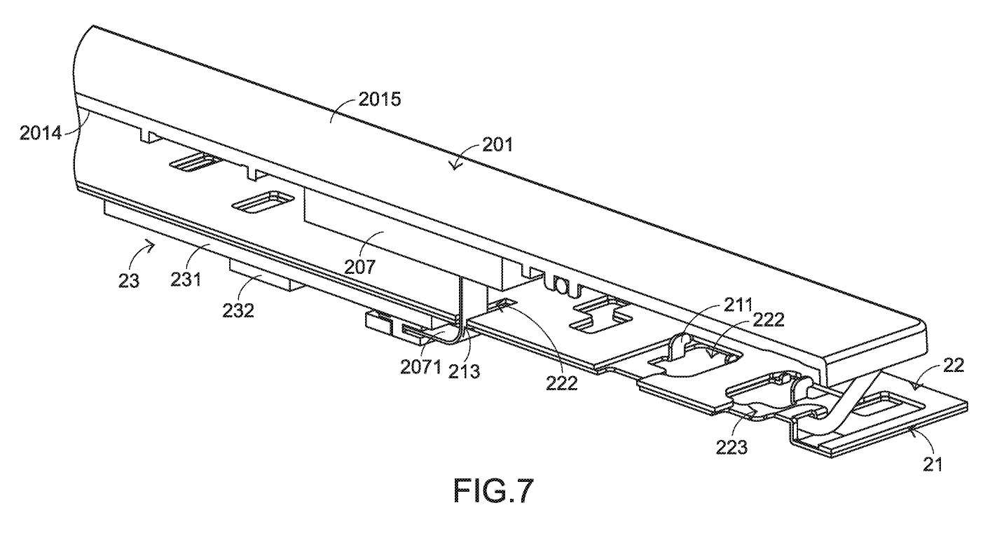

Please refer to FIGS. 5, 6 and 7. FIG. 6 is a schematic perspective view illustrating a portion of the keyboard device according to the embodiment of the present invention. FIG. 7 is a schematic cutaway view illustrating a portion of the keyboard device according to the embodiment of the present invention. In FIGS. 6 and 7, a combination of the scissors-type connecting element 202, the elastic element 203, the first stabilizer bar 204, the second stabilizer bar 205, the switch circuit board 22, the supporting plate 21 and the identification module 23 is shown. After the electric connection part 2071 of the fingerprint sensing module 207 is penetrated through the first opening 222 of the switch circuit board 22 and the third opening 213 of the supporting plate 21 sequentially, the electric connection part 2071 of the fingerprint sensing module 207 is electrically connected with the identification module 23. For succinctness, the scissors-type connecting element 202 and the elastic element 203 are not shown in FIG. 7. As shown in FIGS. 5 and 7, the fingerprint sensing module 207 and the reinforcement element 206 are disposed on the inner surface 2014 of the keycap 201.

Please refer to FIGS. 5, 6 and 7 again. While the keycap 201 of any key structure 20′ is depressed, the keycap 201 is moved downwardly relative to the supporting plate 21. Since the scissors-type connecting element 202 is pushed by the keycap 201, the scissors-type connecting element 202 is correspondingly swung. Moreover, as the keycap 201 is moved downwardly to push the elastic element 203, the elastic element 203 is subjected to deformation to trigger the corresponding key switch 221. Consequently, the corresponding key signal is generated. When the key structure 20′ is no longer depressed, the keycap 201 is moved upwardly relative to the supporting plate 21 in response to a restoring elastic force of the elastic element 203. As the keycap 201 is moved upwardly, the scissors-type connecting element 202 is correspondingly swung and switched from a stacked state to an open-scissors state. Consequently, the keycap 201 is returned to its original position.

The operations of depressing the fingerprint sensing module 207 and the identification module 23 of the keyboard device 2 will be described as follows. When the user's finger is placed on the outer surface 2015 of the keycap 201 at a position corresponding to the fingerprint sensing module 207, the invisible light emitted by the fingerprint sensing module 207 is projected onto the finger. Consequently, the fingerprint information of the finger is acquired. Then, the fingerprint information is transmitted from the fingerprint sensing module 207 to the control unit 232 through the electric connection part 2071 and the main circuit board 231. Then, the control unit 232 compares the predetermined fingerprint data with the received fingerprint information. If the fingerprint information complies with the predetermined fingerprint data, the control unit 232 judges that the fingerprint information is successfully identified. Then, the unlocking operation is performed. Whereas, if the fingerprint information does not comply with the predetermined fingerprint data, the control unit 232 judges that the fingerprint information is not successfully identified. Meanwhile, the unlocking operation is not done. At the same time, a failed identification message is generated to prompt the user.

The following two aspects should be specially described. Firstly, the fingerprint sensing module 207 is disposed on the inner surface 2014 of the keycap 201 and not exposed outside, and thus the user cannot realize which key structure is equipped with the fingerprint sensing module 207. For facilitating the user to realize the position of the fingerprint sensing module 207, a symbol is marked on the outer surface 2015 of the keycap 201 at the position corresponding to the fingerprint sensing module 207. Secondly, the light beam emitted by the fingerprint sensing module of the keyboard device is not restricted to the invisible light. For example, in another embodiment, the fingerprint sensing module emits a visible light. After the visible light is transmitted through the keycap and projected onto the finger, the fingerprint information is acquired. The keycap is made of a light-transmissible material. In other words, the fingerprint sensing module is not restricted to the invisible-light fingerprint sensing module. According to the practical requirements, the fingerprint sensing module is a visible-light fingerprint sensing module.

From the above descriptions, the present invention provides the keyboard device. The fingerprint sensing module is installed on the inner surface of the keycap. Since the fingerprint sensing module is not exposed outside the keycap, the appearance of the keyboard device is aesthetically pleasing. Since the fingerprint sensing module is installed on the inner surface of the keycap, the fingerprint sensing module is movable upwardly or downwardly with the keycap. Consequently, the movement of the keycap is not hindered by the fingerprint sensing module. In other words, the arrangement of the fingerprint sensing module in the keyboard device does not influence the tactile feel of depressing the keycap. Moreover, since the identification module is located under the supporting plate and the identification module is electrically connected with the fingerprint sensing module, the key structure has the fingerprint identification function. In comparison with the conventional technology, the keycap of the keyboard device of the present invention is not equipped with the hollow region. Consequently, the keyboard device has the aesthetically-pleasing appearance and the dust-proof efficacy.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A keyboard device, comprising:
a key structure comprising a keycap and a fingerprint sensing module, wherein the keycap is exposed outside the keyboard device, and the fingerprint sensing module is installed on an inner surface of the keycap, wherein when a finger placed on an outer surface of the keycap is detected by the fingerprint sensing module, a fingerprint information of the finger is acquired;
a switch circuit board located under the key structure, wherein when the switch circuit board is triggered by the key structure, a key signal is generated;
a supporting plate located under the switch circuit board, wherein the key structure and the switch circuit board are supported by the supporting plate; and
an identification module electrically connected with the fingerprint sensing module, and receiving the fingerprint information, wherein the identification module determines whether an unlocking operation is performed according to the fingerprint information,
wherein the fingerprint sensing module is covered by the keycap and not exposed.

2. The keyboard device according to claim 1, wherein the identification module comprises:
a main circuit board located under the supporting plate and electrically connected with an electric connection part of the fingerprint sensing module; and
a control unit disposed on the main circuit board, and receiving the fingerprint information from the fingerprint sensing module through the main circuit board and the electric connection part, wherein if the control unit judges that the fingerprint information is successfully identified, the unlocking operation is performed, wherein if the control unit judges that the fingerprint information is not successfully identified, a failed identification message is generated.

3. The keyboard device according to claim 2, wherein the switch circuit board has a first opening, and the supporting plate has a second opening, wherein the electric connection part of the fingerprint sensing module is penetrated through the first opening and the second opening sequentially and electrically connected with the main circuit board.

4. The keyboard device according to claim 1, wherein the fingerprint sensing module emits an invisible light, wherein after the invisible light is transmitted through the keycap and projected onto the finger on the keycap, the fingerprint information is acquired.

5. The keyboard device according to claim 1, wherein the keycap is made of a plastic material, wherein a transmittance of the plastic material in an invisible spectrum is larger than or equal to 95%, and the refractive index of the plastic material is larger than or equal to 1.5.

6. The keyboard device according to claim 1, wherein the fingerprint sensing module is attached on the inner surface of the keycap through an optical clear adhesive.

7. The keyboard device according to claim 1, wherein the fingerprint sensing module emits a visible light, and the keycap is made of a light-transmissible material, wherein after the visible light is transmitted through the keycap and projected onto the finger on the keycap, the fingerprint information is acquired.

8. The keyboard device according to claim 1, wherein the key structure further comprises:
a stabilizer bar connected with the keycap and located under the keycap;
a scissors-type connecting element connected with the keycap and the supporting plate, wherein the keycap is fixed on the supporting plate through the scissors-type connecting element, so that the keycap is movable relative to the supporting plate; and
an elastic element arranged between the keycap and the switch circuit board, wherein when the elastic element is pushed by the keycap, the switch circuit board is triggered by the elastic element, wherein when the elastic element is not pushed by the keycap, the elastic element provides an elastic force to the keycap.

9. The keyboard device according to claim 8, wherein the supporting plate comprises:
a supporting plate hook disposed on the supporting plate, and connected with the scissors-type connecting element; and
a connecting structure disposed on the supporting plate and connected with the stabilizer bar, and comprising a locking hole, wherein after the stabilizer bar is penetrated through the locking hole, the stabilizer bar is fixed on the supporting plate.

10. The keyboard device according to claim 9, wherein the stabilizer bar comprises:
a linking bar part fixed on a first keycap hook of the keycap, so that the linking bar part is connected with the keycap; and
a hook part located at an end of the linking bar part and aligned with the locking hole, wherein the hook part is penetrated through the locking hole, so that the stabilizer bar is fixed on the supporting plate, wherein the linking bar part and the hook part are integrally formed, and the stabilizer bar is made of a metallic material or a plastic material.
